(19) United States
(12) Patent Application Publication
(10) Pub. No.: US 2010/0093280 A1
(43) Pub. Date: Apr. 15, 2010

(54) Bluetooth connection method and apparatus

(75) Inventors: Dong-Gyu Ahn, Suwon-si (KR); Jong-Kyu Lee, Gwacheon-si (KR); Hak-Ryoul Kim, Seongnam-si (KR)

Correspondence Address: DOCKET CLERK, P.O. DRAWER 800889, DALLAS, TX, 75380, US

(73) Assignee: SAMSUNG ELECTRONICS CO., LTD., Suwon-si (KR)

(21) Appl. No.: 12/587,828

(22) Filed: Oct. 14, 2009

(30) Foreign Application Priority Data
Oct. 15, 2008 (KR) 10-2008-0101166

(51) Int. Cl. H04B 7/00; H04B 17/00; H04B 1/38

(52) U.S. Cl. 455/41.2; 455/67.11; 455/550.1

(57) ABSTRACT

A Bluetooth® connection method and a Bluetooth module for discovering and connecting peripheral Bluetooth devices. An inquiry signal is sent with a minimum transmit power. It is determined if an inquiry response signal is received for a waiting time. A path loss corresponding to each inquiry response signal is calculated when a plurality of inquiry response signals are received for the waiting time, the calculated path losses are compared, and Bluetooth® connection is performed with a Bluetooth® device that sent an inquiry response signal having a lowest path loss.

### CROSS-REFERENCE TO RELATED APPLICATION(S) AND CLAIM OF PRIORITY

The present application is related to and claims the benefit under 35 U.S.C. §119(a) of a Korean Patent Application filed in the Korean Intellectual Property Office on Oct. 15, 2008 and assigned Serial No. 10-2008-0101166, the entire disclosure of which is hereby incorporated by reference.

### TECHNICAL FIELD OF THE INVENTION

The present invention relates generally to Bluetooth® devices, and more particularly, to a method and apparatus for discovering and connecting peripheral Bluetooth® devices.

### BACKGROUND OF THE INVENTION

Bluetooth® (hereinafter “Bluetooth”), a protocol for wirelessly connecting with a variety of terminals and Bluetooth® devices at a rate of about 1 Mbps using a frequency in a 2.4-GHz Industrial, Scientific, Medical (ISM) band, automatically or manually discovers (searches) other peripheral Bluetooth devices, if any, and maintains the connection with them. The term “Bluetooth device” as used herein refers to a device equipped with a Bluetooth module. The Bluetooth devices are adapted to deliver information to the other party's Bluetooth devices by mutually identifying each other using a Bluetooth communication scheme depending on device addresses set in the Bluetooth devices and device names entered by users.

FIG. 1 illustrates several Bluetooth devices existing in a certain space. Here, for example, a mobile phone 10, a headset 20, a notebook Personal Computer (PC) 30, and a printer 40 are situated in a specific space.

Referring to FIG. 1, a description will be given of a process of discovering and connecting conventional Bluetooth devices in a case where the mobile phone 10 is set as a master device or a host device. The mobile phone 10, or a master device, broadcasts a Bluetooth Host Controller Interface (HCI) inquiry signal. The term “HCI inquiry signal” as used herein refers to a signal that the host device sends to discover peripheral Bluetooth devices. The HCI inquire signal also is referred, simply, as an “inquiry signal.”

Upon receipt of the inquiry signal, each of Bluetooth devices, i.e., the headset 20, the notebook PC 30 and the printer 40, sends a response signal to the host device or the mobile phone 10 in reply to the inquiry signal. The response signal from each Bluetooth device may include its address information, or a Bluetooth device address, and information about services supportable by the Bluetooth device.

Hence, the mobile phone 10 can determine not only the existence of the currently connectable Bluetooth devices but also the services supportable by the currently connectable Bluetooth devices by sending an inquiry signal and receiving response signals in replay.

A user may get information about addresses and available services of the currently connectable Bluetooth devices from a list of the determined Bluetooth devices, and may select at least one Bluetooth device and connect with the selected Bluetooth device. Then the user can transmit and receive data to/from the connected device using the Bluetooth communication scheme.

Generally, however, there are not so many Bluetooth devices that a user simultaneously uses through Bluetooth connection. In the foregoing example, when a user talks on the mobile phone 10, the mobile phone 10 may need to attempt Bluetooth connection only to the headset 20 among the peripheral Bluetooth devices. Nevertheless, the mobile phone 10 receives response signals from all of the three Bluetooth devices, i.e., the headset 20, the notebook PC 30 and the printer 40, and provides information about all of the three Bluetooth devices to the user, regardless of the user's intention. Thereafter, the mobile phone 10 connects with the Bluetooth device selected by the user based on the Bluetooth connection scheme.

Such a common Bluetooth connection scheme not only attempts to detect even the Bluetooth devices unnecessary to the user but also performs a process of receiving response signals from such Bluetooth devices, causing an unnecessary time waste for Bluetooth connection. In addition to this, the conventional Bluetooth connection scheme displays even the currently unnecessary Bluetooth devices on a display unit for the user, inconveniencing the user discovering his or her desired Bluetooth device.

### SUMMARY OF THE INVENTION

To address the above-discussed deficiencies of the prior art, it is a primary aspect of the present invention to address at least the above-mentioned problems and/or disadvantages and to provide at least the advantages described below. Accordingly, an aspect of the present invention provides a Bluetooth connection method and apparatus capable of reducing a time required for Bluetooth connection by restrictively detecting only the Bluetooth device necessary to a user and attempting Bluetooth connection only to the detected Bluetooth device.

Another aspect of the present invention provides a Bluetooth connection method and apparatus capable of more increasing user convenience during Bluetooth connection by enabling the connection only to the Bluetooth device needed by a user.

In accordance with one aspect of the present invention, there is provided a Bluetooth connection method in a Bluetooth module, including sending an inquiry signal with a minimum transmit power; determining if an inquiry response signal is received for a waiting time; and calculating a path loss corresponding to each inquiry response signal when a plurality of inquiry response signals are received for the waiting time, comparing the calculated path losses, and performing Bluetooth connection with a Bluetooth device that sent an inquiry response signal having a lowest path loss.

In accordance with another aspect of the present invention, there is provided a Bluetooth connection apparatus including a Bluetooth signal transceiver for transmitting and receiving a signal for Bluetooth communication; and a controller for performing Bluetooth communication by controlling the Bluetooth signal transceiver, and controlling the Bluetooth signal transceiver to send an inquiry signal with a minimum transmit power, calculate a path loss corresponding to each inquiry response signal when a plurality of inquiry response signals are received through the Bluetooth signal transceiver for a waiting time, compare the calculated path losses, and perform Bluetooth connection with a Bluetooth device that sent an inquiry response signal having a lowest path loss.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates several Bluetooth devices existing in a certain space;

FIG. 2 illustrates a Bluetooth module according to an exemplary embodiment of the present invention; and

FIG. 3 illustrates an operation of a Bluetooth module according to an exemplary embodiment of the present invention.

Throughout the drawings, the same drawing reference numerals will be understood to refer to the same elements, features and structures.

### DETAILED DESCRIPTION OF THE INVENTION

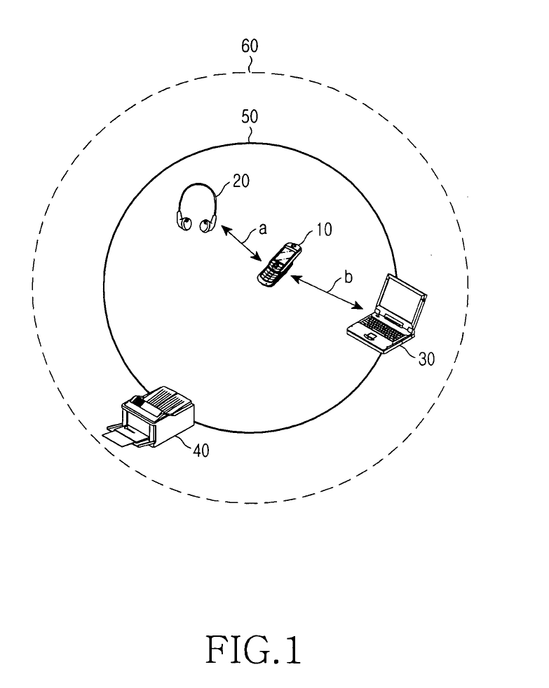

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communications system.

The present invention provides a method for discovering and connecting Bluetooth devices in Bluetooth communication between Bluetooth devices with a built-in Bluetooth module. To this end, the present invention sets a transmit power of an inquiry signal to the lowest level and extends coverage step by step starting from the smallest coverage in performing discovering. If multiple Bluetooth devices are discovered at a specific power level, the invention calculates a path loss for each of the discovered Bluetooth devices using response signals from them. Moreover, the invention selectively connects a Bluetooth device having the lowest path loss by comparing the respective path losses so that the master device may connect with the nearest Bluetooth device.

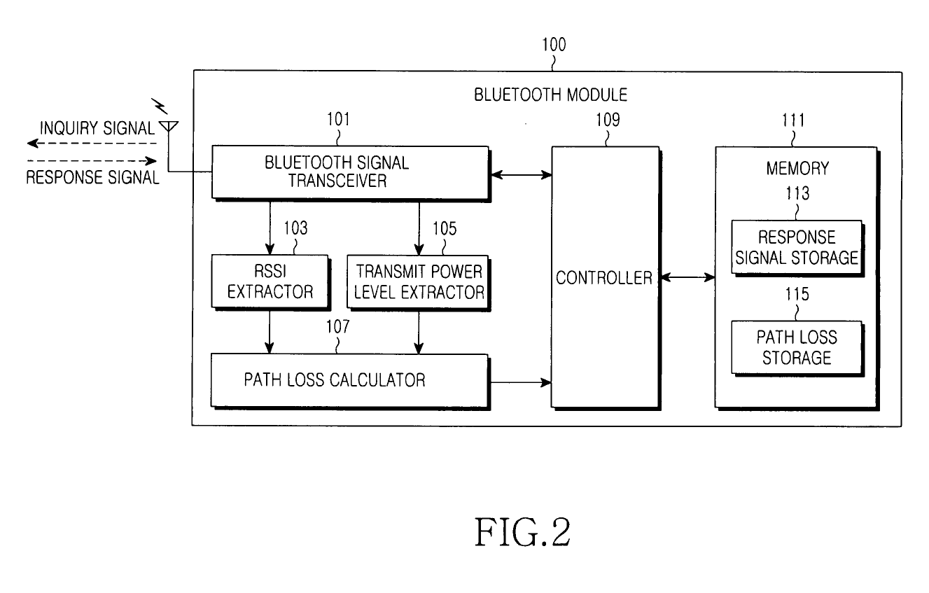

An example of a Bluetooth module to which the present invention is applied is illustrated in FIG. 2. Referring to FIG. 2, a Bluetooth module 100 includes a Bluetooth signal transceiver 101, a Response Signal Strength Indication or Received Signal Strength Indication (RSSI) extractor 103, a transmit power level extractor 105, a path loss calculator 107, a controller 109, and a memory 111 having a response signal storage 113 and a path loss storage 115.

Under the control of the controller 109, the Bluetooth signal transceiver 101 transmits and receives a plurality of types of signals and data used for Bluetooth communication. In accordance with an exemplary embodiment of the present invention, the Bluetooth signal transceiver 101 repeatedly sends an inquiry signal at stated intervals by increasing its transmit power step by step until at least one inquiry response signal is received. In other words, upon receipt of a connection request for the nearest Bluetooth device, the Bluetooth signal transceiver 101 sends an inquiry signal with its minimum transmit power, and waits for receipt of any inquiry response signal for a predetermined waiting time. If no inquiry response signal is received for the waiting time, the Bluetooth signal transceiver 101 sends an inquiry signal after increasing the transmit power by one step. The increasing step of the transmit power may be determined on the basis of the coverage in which the inquiry signal can be delivered. That is, as the transmit power becomes higher, the coverage where the inquiry signal can be delivered becomes broader. Upon receipt of an inquiry response signal within the waiting time, the Bluetooth signal transceiver 101 delivers it to the controller 109.

The controller 109 stores an inquiry response signal received from the Bluetooth signal transceiver 101 in the response signal storage 113 in the memory 111. When one inquiry response signal is received for a waiting time associated with an arbitrary transmit power level, the controller 109 controls the Bluetooth signal transceiver 101 so as to make Bluetooth connection with the Bluetooth device that sent the inquiry response signal. However, when a plurality of inquiry response signals are received for a waiting time associated with the arbitrary transmit power level, the controller 109 controls the Bluetooth signal transceiver 101 so as to deliver the received inquiry response signals to the RSSI extractor 103 and the transmit power level extractor 105.

The RSSI extractor 103 extracts a Received Signal Strength Indication (RSSI) from an inquiry response signal received from the Bluetooth signal transceiver 101 and outputs the extracted RSSI to the path loss calculator 107.

The transmit power level extractor 105 detects a transmit power level from the inquiry response signal received from the Bluetooth signal transceiver 101, and outputs the detected transmit power level to the path loss calculator 107. The detected transmit power level is a transmit power level set in the Bluetooth device that sent the inquiry response signal, and it is included in the inquiry response signal.

The path loss calculator 107 calculates a path loss for an arbitrary inquiry response signal, using the RSSI and the transmit power level received from the RSSI extractor 103 and the transmit power level extractor 105. The path loss is calculated by Equation 1:

Path Loss (dBm)=Transmit Power Level (dBm)−RSSI (dBm) [Eqn. 1]

The path loss calculator 107 outputs the calculated path loss to the controller 109.

The controller 109 stores the path loss received from the path loss calculator 107 in the path loss storage 115. Then the controller 109 compares the path losses corresponding to respective inquiry response signals, and controls the Bluetooth signal transceiver 101 so as to make Bluetooth connection with the Bluetooth device associated with the inquiry response signal having the lowest path loss. This is because as the path loss is lower, its associated Bluetooth device can be determined closer to the host device. Although an error may occur due to a cause such as fading according to environments, the error is negligible because the discovery coverage, or search coverage, is limited in the present invention.

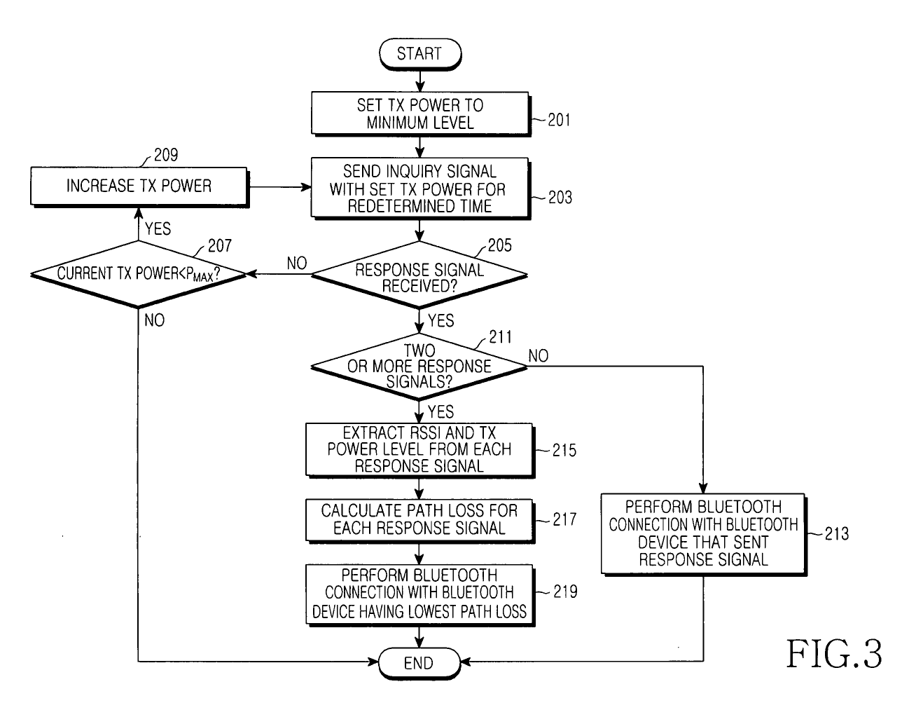

With reference to FIGS. 1 to 3, a description will now be given of an exemplary operation of the Bluetooth module 100 according to the present invention. FIG. 3 illustrates an operation of the Bluetooth module 100 according to an exemplary embodiment of the present invention.

The Bluetooth module 100 according to an exemplary embodiment of the present invention can be mounted in various devices such as, for example, the mobile phone 10, the headset 20, the notebook PC 30 and the printer 40 illustrated in FIG. 1. In the following description, the mobile phone 10 is assumed to have the built-in Bluetooth module 100, for example.

Using a specific menu or a dedicated key, a user of the mobile phone 10 may request the mobile phone 10 to discover the nearest Bluetooth device that he or she desires to access. In the example of FIG. 1, the Bluetooth device nearest to the mobile phone 10 is the headset 20. The Bluetooth module 100 in the mobile phone 10, which has started connecting with the nearest Bluetooth device upon user's request, sets its transmit power (Tx power) to the lowest level in order to minimize the discovery coverage in step 201. In step 203, the Bluetooth module 100 sends an inquiry signal with the set transmit power level for a predetermined time, i.e., a waiting time, and then determines if an inquiry response signal is received for the waiting time.

If no inquiry response signal is received for the waiting time in step 205, the Bluetooth module 100 compares the current transmit power with the maximum transmit power P_{MAX} for the inquiry signal in step 207. If the current transmit power is lower than the maximum transmit power P_{MAX} in step 207, the Bluetooth module 100 increases the transmit power level in step 209 and then proceeds to step 203. However, if the current transmit power is higher than or equal to the maximum transmit power P_{MAX}, the Bluetooth module 100 ends the operation, determining that there is no Bluetooth device in the coverage where it can perform Bluetooth communication. The maximum transmit power P_{MAX} for the inquiry signal may be determined on the basis of the distance at which Bluetooth communication is possible.

Meanwhile, when an inquiry response signal is received within the waiting time in step 205, the Bluetooth module 100 determines in step 211 if the number of inquiry response signals received within the same waiting time is two or more. If only one inquiry response signal is received within the waiting time, the Bluetooth module 100 performs Bluetooth connection with the Bluetooth device that sent the inquiry response signal, in step 213, and then ends the Bluetooth connection-related operation.

For example, in FIG. 1, assuming that the headset 20 and the notebook PC 30 do not exist in a first discovery coverage 50 and only the printer 40 exists in a second discovery range 60, when the mobile phone 10 sent an inquiry signal with a transmit power corresponding to the first discovery coverage 50, the mobile phone 10 could receive no inquiry response signal within the waiting time. Thereafter, if the mobile phone 10 sends an inquiry signal having the second, discovery coverage 60 after increasing the transmit power by one step, the mobile phone 10 will receive an inquiry response signal from the printer 40 for the waiting time. In this case, because the signal sent from the printer 40 is the only inquiry response signal received, the mobile phone 10 will perform Bluetooth connection with the printer 40.

Referring back to FIG. 3, if the number of inquiry response signals received within the same time period is two or more in step 211, the Bluetooth module 100 extracts an RSSI and a transmit power level from each of the received response signals in step 215. The Bluetooth module 100 calculates a path loss for each of the inquiry response signals using the extracted RSSI and transmit power level in step 217. The Bluetooth module performs a Bluetooth connection with the Bluetooth device having the lowest path loss in step 219.

For example, if the headset 20 and the notebook PC 30 exist in the first discovery coverage 50 as in FIG. 1, the mobile phone 10 will receive an inquiry response signal from each of the headset 20 and the notebook PC 30 after sending an inquiry response signal having a first transmit power. Accordingly, the mobile phone 10 detects an RSSI and a transmit power level set in the headset 20 from the inquiry response signal received from the headset 20, and calculates a path loss corresponding to the headset 20. The mobile phone 10 also detects an RSSI and a transmit power level set in the notebook PC 30 from the inquiry response signal received from the notebook PC 30, and calculates a path loss corresponding to the notebook PC 30.

Because a distance “a” between the mobile phone 10 and the headset 20 is shorter than a distance “b” between the mobile phone 10 and the notebook PC 30 as illustrated in FIG. 1, the path loss corresponding to the headset 20 will be lower than the path loss corresponding to the notebook PC 30. Therefore, the mobile phone 10 will perform Bluetooth connection with the headset 20.

In this manner, the present invention predicts the distance between the Bluetooth device performing inquiry scanning and the peripheral Bluetooth device, using the path losses of the inquiry response signals. Thus, the invention can make it possible to predict the nearer Bluetooth device, even when a transmit power of a Bluetooth device located farther from the host device is higher than a transmit power of a Bluetooth device located closer to the host device.

For example, when a transmit power level of an inquiry response signal from the notebook PC 30 is higher than a transmit power level of an inquiry response signal from the headset 20, an RSSI of the inquiry response signal from the notebook PC 30 may be higher than an RSSI of the inquiry response signal from the headset 20. In this case, if only the RSSI is taken into account, it could be determined that the notebook PC 30 is located closer to the host device or the mobile terminal 10.

However, since the present invention predicts the distances by calculating path losses using the RSSIs and the transmit power levels of the inquiry response signals, it is possible to more accurately predict the relative distances between the Bluetooth devices.

As is apparent from the foregoing description, the present invention can reduce the time required during Bluetooth connection by restrictively detecting only the Bluetooth device necessary to the user and attempting the Bluetooth connection only to the detected Bluetooth device. In addition, the present invention increases user convenience during Bluetooth connection by enabling the connection only to the Bluetooth device needed by a user. Moreover, the present invention can detect the Bluetooth device relatively closer to the master device and connect only with the detected Bluetooth device.

While the invention has been shown and described with reference to a certain exemplary embodiments thereof, it will be understood by those skilled in the art that various changes in form and details may be made therein without departing from the spirit and scope of the invention as defined by the appended claims and their equivalents. For example, the RSSI extractor 103 and the transmit power level extractor 105 may constitute a single component. Also, the RSSI extractor 103 and the transmit power level extractor 105 may be included in the controller 109. In this case, the controller 109 may serve as the RSSI extractor 103 and the transmit power level extractor 105.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for establishing a Bluetooth® connection with a Bluetooth module, the method comprising:
sending an inquiry signal with a minimum transmit power;
determining if one inquiry response signal is received during a waiting time or a plurality of inquiry response signals are received; and
performing Bluetooth connection with a Bluetooth device that sent an inquiry response signal having a lowest path loss from one of the one inquiry response signal and the plurality of inquiry response signals.

2. The Bluetooth® connection method of claim 1, further comprising:
calculating a path loss corresponding to each of a plurality of inquiry response signals if the plurality of inquiry response signals are received during the waiting time; and
comparing the calculated path losses.

3. The Bluetooth® connection method of claim 1, further comprising increasing a transmit power by a predetermined level when no inquiry response signal is received for the waiting time, sending the inquiry signal with the increased transmit power.

4. The Bluetooth® connection method of claim 3, further comprising re-performing determining, calculating, comparing and performing.

5. The Bluetooth® connection method of claim 2, wherein the step calculating comprises:
detecting, when the plurality of inquiry response signals are received during the waiting time, from each inquiry response signal, a Received Signal Strength Indication (RSSI) and a transmit power level included in each inquiry response signal;
calculating a path loss corresponding to each of the inquiry response signals using the detected RSSI and the detected transmit power level;
determining an inquiry response signal having a lowest path loss by comparing the calculated path losses; and
performing Bluetooth connection with a Bluetooth device that sent the determined inquiry response signal.

6. The Bluetooth® connection method of claim 4, wherein the path loss is calculated by the following equation,
Path Loss (dBm)=Transmit Power Level (dBm)−RSSI (dBm).

7. The Bluetooth® connection method of claim 1, further comprising performing, when one inquiry response signal is received during the waiting time, a Bluetooth connection with a Bluetooth device that sent the one inquiry response signal.

8. A Bluetooth® connection apparatus comprising:
a Bluetooth signal transceiver for transmitting and receiving a signal for Bluetooth communication; and
a controller for performing Bluetooth communication by controlling the Bluetooth signal transceiver, the controller is configured to control the Bluetooth signal transceiver to send an inquiry signal with a minimum transmit power, to determine if one inquiry response signal is received during a waiting, time or if a plurality of inquiry response signals are received during the waiting time, and perform Bluetooth connection with a Bluetooth device that sent an inquiry response signal having a lowest path loss from one of the one inquiry response signal and the plurality of inquiry response signals.

9. The Bluetooth® connection apparatus of claim 8, the controller further configured to cause the Bluetooth signal transceiver to calculate a path loss corresponding to each inquiry response signal when a plurality of inquiry response signals are received through the Bluetooth signal transceiver for a waiting time, compare the calculated path losses.

10. The Bluetooth® connection apparatus of claim 9, wherein the controller detects a Received Signal Strength Indication (RSSI) and a transmit power level included in each of the inquiry response signals, from each of the plurality of inquiry response signals, and calculates a path loss corresponding to each of the inquiry response signals using the detected RSSI and the detected transmit power level.

11. The Bluetooth® connection apparatus of claim 8, wherein when no inquiry response signal is received for the waiting time, the controller increases a transmit power by a predetermined level, sends the inquiry signal with the increased transmit power, and re-determines if an inquiry response signal is received.

12. The Bluetooth® connection apparatus of claim 8, wherein when one inquiry response signal is received for the waiting time, the controller controls the Bluetooth signal transceiver to perform Bluetooth connection with a Bluetooth device that sent the one inquiry response signal.

13. The Bluetooth® connection apparatus of claim 8, wherein the path loss is calculated by the following equation,
Path Loss (dBm)=Transmit Power Level (dBm)−RSSI (dBm).

14. A Bluetooth® connection system comprising a first Bluetooth device capable of performing Bluetooth communications with a plurality of second Bluetooth devices, the first Bluetooth device comprising:
a Bluetooth signal transceiver for transmitting and receiving a signal for Bluetooth communication; and
a controller for performing Bluetooth communication by controlling the Bluetooth signal transceiver, the controller is configured to control the Bluetooth signal transceiver to send an inquiry signal with a minimum transmit power, to determine if one inquiry response signal is received during a waiting time or if a plurality of inquiry response signals are received during the waiting time, and perform Bluetooth connection with a Bluetooth device that sent an inquiry response signal having a lowest path loss from one of the one inquiry response signal and the plurality of inquiry response signals.

15. The Bluetooth® connection system of claim 14, wherein the Bluetooth controller is configured to receive distinguish respective distances of a number of the second Bluetooth devices.

16. The Bluetooth® connection system of claim 14, the controller further configured to cause the Bluetooth signal transceiver to calculate a path loss corresponding to each inquiry response signal when a plurality of inquiry response signals are received through the Bluetooth signal transceiver for a waiting time, compare the calculated path losses.

17. The Bluetooth® connection system of claim 16, wherein the controller detects a Received Signal Strength Indication (RSSI) and a transmit power level included in each of the inquiry response signals, from each of the plurality of inquiry response signals, and calculates a path loss corresponding to each of the inquiry response signals using the detected RSSI and the detected transmit power level.

18. The Bluetooth® connection system of claim 14, wherein when no inquiry response signal is received for the waiting time, the controller increases a transmit power by a predetermined level, sends the inquiry signal with the increased transmit power, and re-determines if an inquiry response signal is received.

19. The Bluetooth® connection system of claim 14, wherein when one inquiry response signal is received for the waiting time, the controller controls the Bluetooth signal transceiver to perform Bluetooth connection with a Bluetooth device that sent the one inquiry response signal.

20. The Bluetooth® connection system of claim 14, wherein the path loss is calculated by the following equation,
Path Loss (dBm)=Transmit Power Level (dBm)−RSSI (dBm).
